(19) United States
(12) Patent Application Publication
(10) Pub. No.: US 2007/0257880 A1
(43) Pub. Date: Nov. 8, 2007

(54) DRIVE CURRENT GENERATOR, LED DRIVER, ILLUMINATION DEVICE, AND DISPLAY DEVICE

(75) Inventors: Shigeharu Nakao, Kyoto-shi (JP); Yuji Omiya, Kashihara-shi (JP)

Correspondence Address: FISH & RICHARDSON P.C., P.O. BOX 1022, MINNEAPOLIS, MN, 55440-1022, US

(73) Assignee: ROHM CO., LTD., Kyoto (JP)

(21) Appl. No.: 11/742,889

(22) Filed: May 1, 2007

(30) Foreign Application Priority Data
May 8, 2006 (JP) 2006-128938

(51) Int. Cl. G09G 3/36

(52) U.S. Cl. 345/102

(57) ABSTRACT

A drive current generator that supplies a desired drive current to an LED has: a drive transistor that is connected in series between one end of the LED and a ground; a first current control portion that performs conductivity control of the drive transistor in such a way that a monitoring voltage commensurate with a current flowing through a reference resistor equals a predetermined reference voltage, and that produces an intermediate current that behaves in the same way as a drive current; a current mirror portion that produces a mirror current commensurate with the intermediate current at a given ratio, and that feeds the mirror current thus produced back to the reference resistor; and a second current control portion that keeps the ratio of the drive current to the intermediate current at a given value. With this configuration, it is possible to supply a desired drive current to the load while minimizing the reduction in efficiency.

This application is based on Japanese Patent Application No. 2006-128938 filed on May 8, 2006, the contents of which are hereby incorporated by reference.

### BACKGROUND OF THE INVENTION

1. Field of the Invention

The present invention relates to drive current generators that supply a desired drive current to a load, and to LED (light-emitting diode) drivers, illumination devices, and display devices incorporating such drive current generators. For example, the present invention relates to an LED backlight system for liquid crystal displays.

2. Description of Related Art

FIGS. 6A and 6B are block diagrams each showing an example of a conventional LED driver.

As shown in FIG. 6A, a conventional LED driver includes, as a means for generating a drive current i of a light-emitting diode LED, a drive transistor N0, a sense resistor Rs1, and an amplifier AMP. This conventional LED driver is so configured as to perform conductivity control of the drive transistor N0 in such a way that a feedback voltage Va(=i×r) derived from one end of the sense resistor Rs1 (having a resistance r) equals a predetermined reference voltage Vref (see, for example, JP-A-2002-359090).

In a case where one of a plurality of drive currents i1˜in is selected for use, as shown in FIG. 6B, an appropriate sense resistor is selected from among the sense resistors Rs1 to Rsn (having resistances r1 to rn; n≧2) arranged in parallel by using switches SW1 to SWn.

Certainly, with the conventional LED drivers shown in FIGS. 6A and 6B, it is possible to supply a desired drive current i to a light-emitting diode LED that serves as a load.

However, the LED drivers shown in FIGS. 6A and 6B have the following drawback. For the LED driver shown in FIG. 6A, since it has a configuration in which the sense resistor Rs1 as well as the drive transistor N0 is connected in series between the cathode of the light-emitting diode LED and a ground, a battery voltage Vbat needed to make the light-emitting diode LED emit light is given by equation (1) below.

$$\begin{matrix}Vbat = Vf + Vsat + Va \\ = Vf + Vsat + ( i \times r )\end{matrix} \qquad ( 1 )$$

For the LED driver shown in FIG. 6B, since it has a configuration in which one of the sense resistors Rs1 to Rsn and one of the switches SW1 to SWn as well as the drive transistor N0 are connected in series between the cathode of the light-emitting diode LED and the ground, a battery voltage Vbat needed to make the light-emitting diode LED emit light is given by equation (2) below.

$$\begin{matrix}Vbat = Vf + Vsat + Va \\ = Vf + Vsat + Vloss + ( i n \times r n )\end{matrix} \qquad ( 2 )$$

In the above equations (1) and (2), “Vf” represents the forward voltage drop of the light-emitting diode LED, “Vsat” represents the saturation voltage of the drive transistor N0, and “Vloss” represents the saturation voltage of one of the transistors corresponding to the switches SW1 to SWn.

As described above, in the conventional LED drivers shown in FIGS. 6A and 6B, the battery voltage Vbat has to be set higher than necessary due to the presence of the feedback voltage Va (e.g., 0.1 V) to make the light-emitting diode LED emit light. This undesirably reduces efficiency.

### SUMMARY OF THE INVENTION

In view of the conventionally experienced problems described above, an object of the present invention is to provide drive current generators that can supply a desired drive current to a load while minimizing the reduction in efficiency, and to provide LED drivers, illumination devices, and display devices provided with such drive current generators.

To achieve the above object, according to one aspect of the present invention, a drive current generator that supplies a desired drive current to a load includes: a drive transistor that is connected in series between one end of the load and a ground; a first current control portion that performs conductivity control of the drive transistor in such a way that a monitoring voltage commensurate with a current flowing through a reference resistor equals a predetermined reference voltage, and that produces an intermediate current that behaves in the same way as a drive current to be supplied to the load; a current mirror portion that produces a mirror current commensurate with the intermediate current at a given ratio, and that feeds the mirror current thus produced back to the reference resistor; and a second current control portion that keeps the ratio of the drive current to the intermediate current at a given value.

Other features, elements, steps, advantages and characteristics of the present invention will become more apparent from the following detailed description of preferred embodiments thereof with reference to the attached drawings.

### BRIEF DESCRIPTION OF THE DRAWINGS

FIG. 1 is a block diagram showing an embodiment of a display device according to the invention;

FIG. 2 is a circuit diagram showing an embodiment of a drive current generator 22;

FIG. 3 is a circuit diagram showing a modified example of the drive current generator 22;

FIG. 4 is a circuit diagram showing another modified example of the drive current generator 22;

FIG. 5 is a circuit diagram illustrating a case in which a light-emitting portion 3 includes a plurality of light-emitting diodes arranged in parallel; and

FIGS. 6A and 6B are block diagrams each showing an example of a conventional LED driver.

### DETAILED DESCRIPTION OF PREFERRED EMBODIMENTS

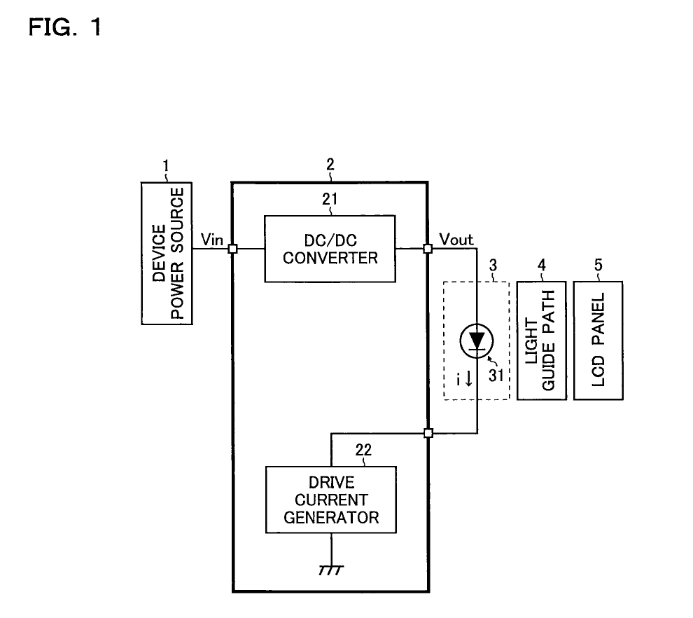

FIG. 1 is a block diagram showing an embodiment of a display device according to the invention. As shown in this figure, the display device of this embodiment is a transmissive liquid crystal display including a device power source 1, an LED driver IC 2, a light-emitting portion 3, a light guide path 4, and a liquid crystal display panel 5 (hereinafter “LCD (liquid crystal display) panel 5”).

The device power source 1 supplies electric power to the LED driver IC 2 and other parts of the display device; it may be an AC/DC converter that produces a DC (direct-current) voltage from a commercially distributed AC (alternating-current) voltage, or a battery such as a rechargeable battery.

Supplied with an input voltage Vin from the device power source 1, the LED driver IC 2 drives and controls a light-emitting diode (hereinafter “LED”) 31 that forms the light-emitting portion 3. The LED driver IC 2 includes: a DC/DC converter 21 that produces, from the input voltage Vin, a desired output voltage Vout to be applied to the anode of the LED 31; and a drive current generator 22 that supplies a desired drive current i to the LED 31. The configuration and operation of the drive current generator 22 will be specifically described later.

The light-emitting portion 3 is composed of the LED 31; it produces illumination light, which is used as backlight that illuminates the LCD panel 5 from behind via the light guide path 4. With this configuration in which the LED is used as a backlight, compared with a configuration in which a fluorescent tube or the like is used as a backlight, it is possible to offer such benefits as low electric power consumption, longer life, reduced amount of heat generated, and space saving.

The LED 31 that forms the light-emitting portion 3 is composed of three LED elements emitting red, green, and blue light respectively; it produces illumination light of a desired color (in this embodiment, white) by mixing together light emitted from these three LED elements. With the configuration in which such a white LED is used as a backlight, compared with a configuration in which a fluorescent tube or the like is used as a backlight, it is possible to expand the color reproduction range of the LCD panel 5.

The light guide path 4 allows light produced by the light-emitting portion 3 to pass therethrough in such a way as to provide even illumination across the entire surface of the LCD panel 5. The light guide path 4 is formed with a reflecting sheet and a light guide sheet (a transparent sheet having a specially treated surface).

The LCD panel 5 is formed with two glass plates having liquid crystal sealed therebetween. By applying a voltage to the liquid crystal, the orientation of the liquid crystal molecules is changed in such a way as to increase or decrease the transmissivity of light radiated from the light-emitting portion 3 onto the back of the LCD panel 5 via the light guide path 4. In this way, the LCD panel 5 produces images. Note that the LCD panel 5 is controlled by an unillustrated LCD controller so as to produce images.

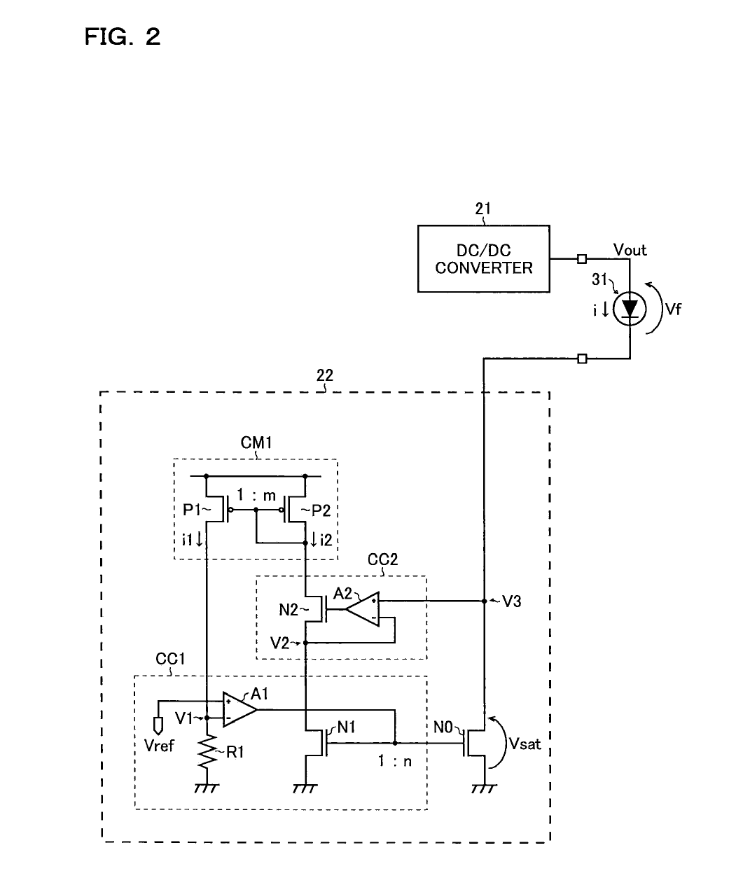

Next, the configuration and operation of the drive current generator 22 will be described in detail with reference to FIG. 2.

FIG. 2 is a circuit diagram showing an embodiment of the drive current generator 22.

As shown in FIG. 2, the drive current generator 22 of this embodiment includes, as its constituent elements, N-channel field-effect transistors N0 to N2, P-channel field-effect transistors P1 and P2, amplifiers A1 and A2, and a reference resistor R1 (having a resistance r).

The drain of the transistor N0 is connected to the cathode of the LED 31, the source thereof is connected to a ground, and the gate thereof is connected to the gate of the transistors N1. The drain of the transistors N1 is connected to the source of the transistor N2, and the source thereof is connected to the ground. The drain of the transistor N2 is connected to the drain of the transistor P2. The sources of the transistors P1 and P2 are connected to a power supply line. The gates of the transistors P1 and P2 are connected to the drain of the transistor P2. The drain of the transistor P1 is connected to the ground via the reference resistor R1.

The non-inverting input terminal (+) of the amplifier A1 is connected to a point to which a reference voltage Vref is applied, the inverting input terminal (−) thereof is connected to one end of the reference resistor R1, and the output terminal thereof is connected to the gates of the transistors N0 and N1.

The non-inverting input terminal (+) of the amplifier A2 is connected to the drain of the transistor N0, the inverting input terminal (−) thereof is connected to the drain of the transistors N1, and the output terminal thereof is connected to the gate of the transistor N2.

In the drive current generator 22 configured as described above, the transistor N0 is connected in series between the cathode of the LED 31 and the ground, and serves as a drive transistor that supplies a desired drive current i to the LED 31.

The drive current generator 22 configured as described above includes, as its constituent functional blocks, a first current control portion CC1, a current mirror portion CM1, and a second current control portion CC2.

The first current control portion CC1 is composed of the reference resistor R1, the amplifier A1, and the transistors N1. The first current control portion CC1 performs conductivity control of the drive transistor N0 in such a way that a monitoring voltage V1 commensurate with a mirror current i1 flowing through the reference resistor R1 equals a predetermined reference voltage Vref, and produces an intermediate current i2 that behaves in the same way as the drive current i.

The current mirror portion CM1 is composed of the transistors P1 and P2. The current mirror portion CM1 produces the mirror current i1 commensurate with the intermediate current i2 at a given ratio, and feeds the mirror current i1 thus produced back to the reference resistor R1. The drain of the transistor P1 serves as an output node of the mirror current i1, and the drain of the transistor P2 serves as an input node of the intermediate current i2.

The second current control portion CC2 is composed of the amplifier A2 and the transistor N2, and keeps the ratio of the drive current i to the intermediate current i2 at a given value. More specifically, in the second current control portion CC2, conductivity control of the transistor N2 is performed in such a way that the drain voltage V2 of the transistors N1 equals the drain voltage V3 of the drive transistor N0 (the cathode voltage of the LED 31). Thanks to the operation described above, the drain voltages of the transistors N0 to N1 relative to the ground are made equal to each other, making it possible to make the drive current i and the intermediate current i2 completely mirror to each other.

In the drive current generator 22 configured as described above, the element size of the transistors P1 and P2 is so designed that, in the current mirror portion CM1, the ratio of the mirror current i1 to the intermediate current i2 is 1:m (>1).

As mentioned earlier, in the first current control portion CC1, feedback control of the mirror current i1 is performed so that the monitoring voltage V1 equals the reference voltage Vref.

Thus, the mirror current i1 and the intermediate current i2 are given by equations (3) and (4) below.

$$\begin{matrix}\begin{matrix}i 1 = V 1 / r \\ = Vref / r\end{matrix} & ( 3 ) \\ \begin{matrix}i 2 = m \cdot i 1 \\ = m \cdot Vref / r\end{matrix} & ( 4 )\end{matrix}$$

On the other hand, in the drive current generator 22 configured as described above, the element size of the transistors N0 to N1 are so designed that, in the second current control portion CC2, the ratio of the intermediate current i2 to the drive current i is 1:n (>1).

Thus, the drive current i supplied to the LED 31 is given by equation (5) below.

$$\begin{matrix}i = n \cdot i 2 \\ = m \cdot n \cdot Vref / r\end{matrix} \qquad ( 5 )$$

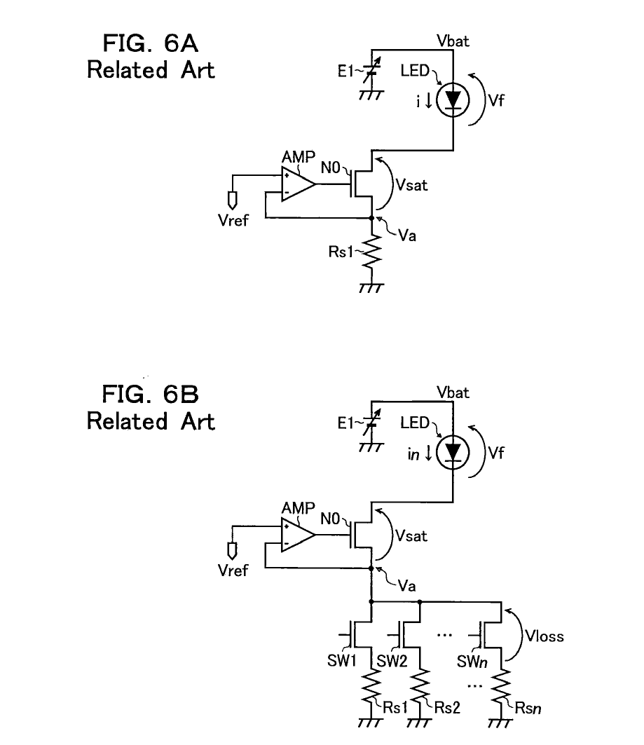

As described above, with the drive current generator 22 configured as described above, unlike the conventional configuration shown in FIGS. 6A and 6B, it is possible to supply a desired drive current i commensurate with the reference voltage Vref to the LED 31 without placing a sense resistor between the cathode of the LED 31 and the ground.

In this case, an output voltage Vout needed to make the LED 31 emit light is given by equation (6) below.
Vout=Vf+Vsat (6)

In the above equation (6), “Vf” represents the forward voltage drop of the LED 31, and “Vsat” represents the saturation voltage of the drive transistor N0.

As will be understood from a comparison between the above equation (6) and the equations (1) and (2) described earlier, with the LED driver IC 2 of this embodiment, as compared with the conventional configuration shown in FIGS. 6A and 6B, it is possible to decrease the cathode voltage of the LED 31 as low as the saturation voltage Vsat of the drive transistor N0 (e.g., 50 to 100 mV). This decreases the output voltage Vout, making it possible to enhance the efficiency of a system as a whole, and accordingly contributing to a reduction in the electric power consumption of illumination devices and display devices provided with the LED driver IC 2.

Additionally, in the drive current generator 22 of this embodiment, as described above, the ratio of the mirror current i1 to the intermediate current i2 is set to 1:m (>1), and the ratio of the intermediate current i2 to the drive current i is set to 1:n (>1). With this configuration, it is possible to make the mirror current i1 and the intermediate current i2 consumed by the drive current generator 22 smaller than the drive current i supplied to the LED 31, making it possible to minimize the increase in the electric power consumption due to the addition of the drive current generator 22.

In particular, if the invention is applied to illumination devices incorporated in electronic apparatuses such as PDAs (personal digital/data assistants) and portable telephone terminals and using a battery as the device power source 1, it is possible to prolong the battery life of the electronic apparatuses.

The embodiment described above deals with an example in which the invention is applied to a transmissive liquid crystal display device. This, however, is not meant to limit the application of the invention in any way; the invention finds wide application in drive current generator s, illumination devices, or display devices of any other type.

The invention may be practiced in any other manner than specifically described above, with any modification or variation made within the spirit of the invention.

For example, the embodiment described above deals with an example in which an LED that produces white light by mixing together red, green, and blue light is used. However, needless to say, the invention is applicable also to a configuration using an LED that emits light of a desired color by mixing together light of any other color than is specifically described above or an LED that emits monochromatic light.

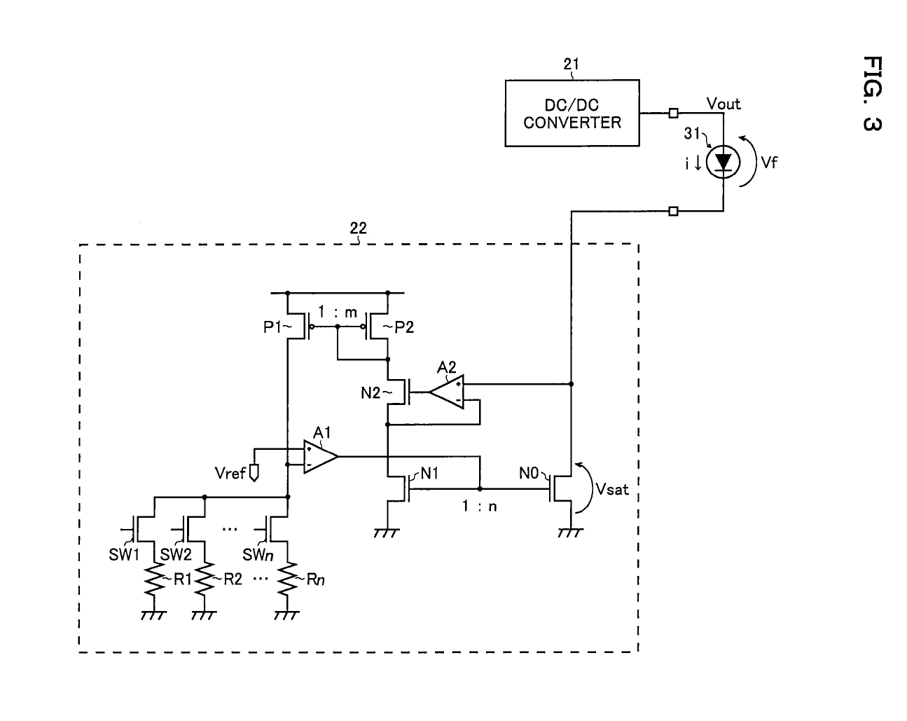

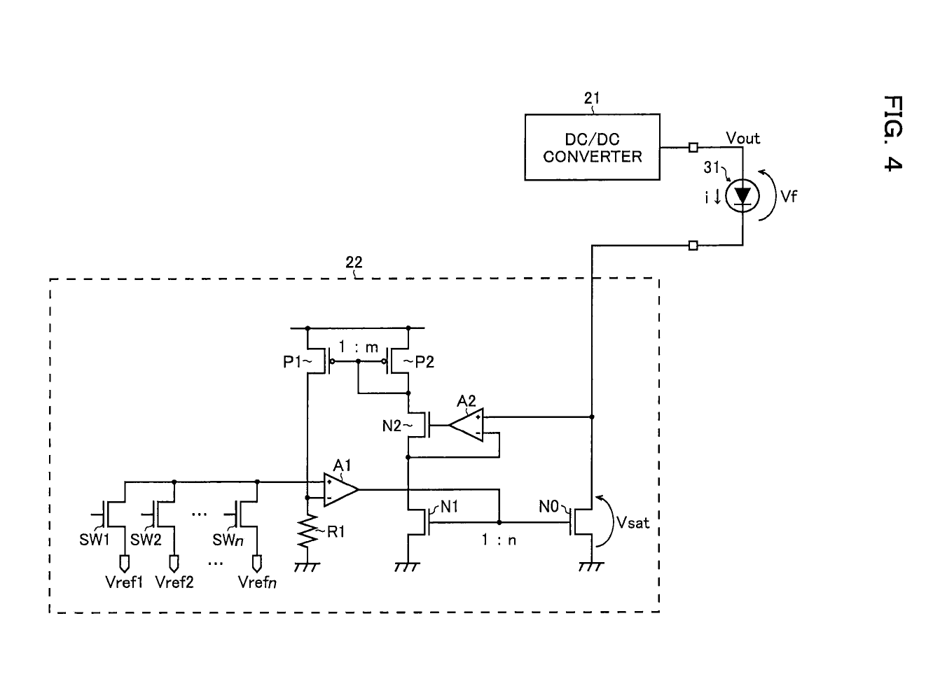

The embodiment described above deals with a configuration in which the drive current i of the LED 31 is set to a fixed value. This, however, is not meant to limit the application of the invention in any way. For example, the drive current i of the LED 31 may be set variably by adopting a configuration in which, as shown in FIG. 3, an appropriate reference resistor is selected from among reference resistors R1 to Rn (n≧2) arranged in parallel by using switches SW1 to SWn, or a configuration in which, as shown in FIG. 4, an appropriate reference voltage is selected from among reference voltage Vref1 to Vrefn (n≧2) applied in parallel by using switches SW1 to SWn. It is to be noted that, even in a case where the configuration modified as described above is adopted, the output voltage Vout needed to make the LED 31 emit light is given by the equation (6) described above. Thus, also in this case, it is possible to supply a desired drive current i to the LED 31 while minimizing the reduction in efficiency.

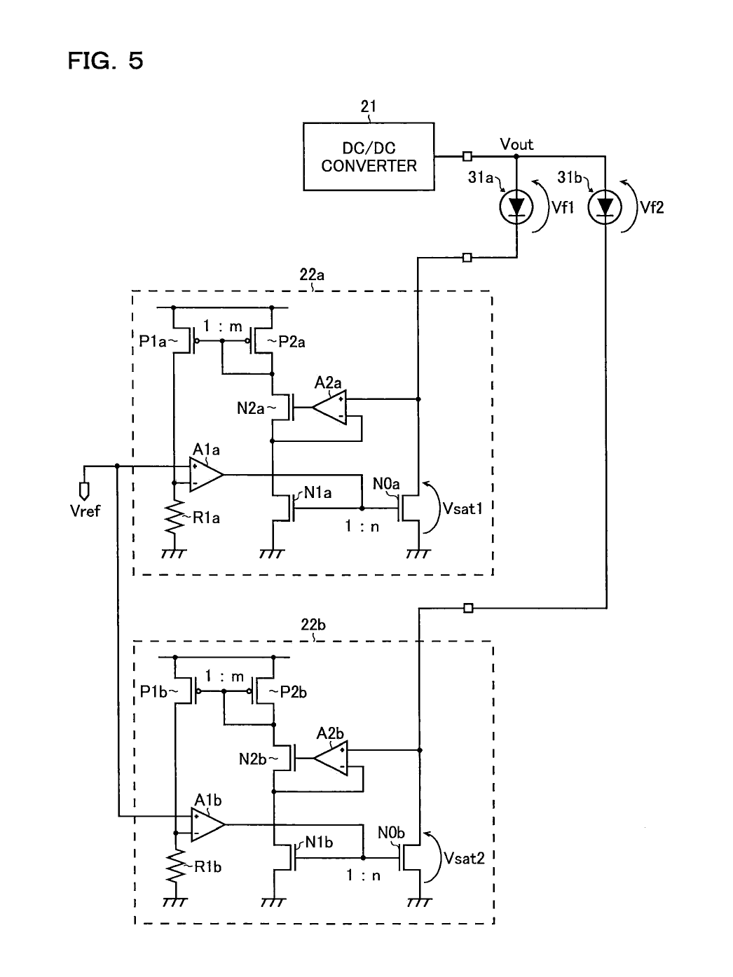

The embodiment described above deals with a configuration in which a desired drive current i is supplied to a single LED 31. This, however, is not meant to limit the application of the invention in any way; the invention is applicable also to, for example, a configuration in which, as shown in FIG. 5, a plurality of drive current generators 22a and 22b configured in the same manner as in the embodiment described above are provided respectively for a plurality of LEDs 31a and 31b arranged in parallel for supplying a desired drive current to the LEDs 31a and 31b, and the drive current generators 22a and 22b share a point to which a reference voltage Vref is applied. With this configuration, it is possible to easily match the drive current amounts of the plurality of LEDs with each other. In a case where the configuration modified as described above is adopted, an output voltage Vout needed to make the LEDs 31a and 31b emit light is either (Vf1+Vsat1) or (Vf2+Vsat2), whichever is higher.

The invention offers the following advantages: it helps realize drive current generators that can supply a desired drive current to a load while minimizing the reduction in efficiency; hence, it helps realize LED drivers, illumination devices, and display devices provided with such drive current generators.

In terms of industrial applicability, the invention is useful in enhancing the efficiency of a system as a whole that uses a drive current generator. The LED drivers and the illumination devices according to the invention can be used in constructing, for example, a backlight system for liquid crystal displays, and some examples of the display devices provided therewith are liquid crystal television receivers, liquid crystal displays of PDAs, and liquid crystal displays of portable telephones.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the present invention which fall within the true spirit and scope of the invention.

What is claimed is:

1. A drive current generator, comprising:
a drive transistor that is connected in series between one end of a load and a ground;
a first current control portion that performs conductivity control of the drive transistor in such a way that a monitoring voltage commensurate with a current flowing through a reference resistor equals a predetermined reference voltage, and that produces an intermediate current that behaves in a same way as a drive current to be supplied to the load;
a current mirror portion that produces a mirror current commensurate with the intermediate current at a given ratio, and that feeds the mirror current thus produced back to the reference resistor; and
a second current control portion that keeps a ratio of the drive current to the intermediate current at a given value.

2. The drive current generator of claim 1,
wherein the first current control portion comprises:
a reference resistor that is connected, at one end thereof, to a mirror current output node of the current mirror portion, and is connected, at another end thereof, to the ground;
a first amplifier that is connected, at one input terminal thereof, to one end of the reference resistor, is connected, at another input terminal thereof, to a point to which the reference voltage is applied, and is connected, at an output terminal thereof, to a control terminal of the drive transistor; and
a first transistor that is connected in series between an intermediate current input node of the current mirror portion and the ground, and is connected, at a control terminal thereof, to the output terminal of the first amplifier,
wherein the second current control portion comprises:
a second transistor that is connected in series between the intermediate current input node of the current mirror portion and one end of the first transistor; and
a second amplifier that is connected, at one input terminal thereof, to one end of the first transistor, is connected, at another input terminal thereof, to one end of the drive transistor, and is connected, at an output terminal thereof, to a control terminal of the second transistor.

3. The drive current generator of claim 1, wherein
a ratio of the mirror current to the intermediate current is 1:m (>1), and a ratio of the intermediate current to the drive current is 1:n (>1).

4. The drive current generator of claim 1, further comprising:
a control portion that changes a resistance of the reference resistor or a voltage value of the reference voltage.

5. An LED driver, comprising:
a drive current generator that supplies a desired drive current to at least one light-emitting diode,
wherein the drive current generator comprises:
a drive transistor that is connected in series between a cathode of the at least one light-emitting diode and a ground;
a first current control portion that performs conductivity control of the drive transistor in such a way that a monitoring voltage commensurate with a current flowing through a reference resistor equals a predetermined reference voltage, and that produces an intermediate current that behaves in a same way as a drive current to be supplied to the at least one light-emitting diode;
a current mirror portion that produces a mirror current commensurate with the intermediate current at a given ratio, and feeds the mirror current thus produced back to the reference resistor; and
a second current control portion that keeps a ratio of the drive current to the intermediate current at a given value.

6. The LED driver of claim 5,
wherein the at least one light-emitting diode comprises a plurality of light-emitting diodes,
wherein the LED driver comprises a plurality of the drive current generators for supplying a desired drive current to the plurality of light-emitting diodes,
wherein the plurality of the drive current generators share a point to which the reference voltage is applied.

7. An illumination device, comprising:
at least one light-emitting diode;
an LED driver that drives and controls the at least one light-emitting diode; and
a device power source that supplies electric power to the LED driver,
wherein the LED driver comprises:
a drive current generator that supplies a desired drive current to the at least one light-emitting diode,
wherein the drive current generator comprises:
a drive transistor that is connected in series between a cathode of the at least one light-emitting diode and a ground;
a first current control portion that performs conductivity control of the drive transistor in such a way that a monitoring voltage commensurate with a current flowing through a reference resistor equals a predetermined reference voltage, and that produces an intermediate current that behaves in a same way as a drive current to be supplied to the at least one light-emitting diode;
a current mirror portion that produces a mirror current commensurate with the intermediate current at a given ratio, and that feeds the mirror current thus produced back to the reference resistor; and
a second current control portion that keeps a ratio of the drive current to the intermediate current at a given value.

8. The illumination device of claim 7,
wherein the at least one light-emitting diode comprises a plurality of light-emitting diodes,
wherein the LED driver comprises a plurality of the drive current generators for supplying a desired drive current to the plurality of light-emitting diodes,
wherein the plurality of the drive current generators share a point to which the reference voltage is applied.

9. The illumination device of claim 7, wherein
the device power source is a battery.

10. A display device, comprising:
a display panel; and
an illumination device that illuminates the display panel,
wherein the illumination device comprises:
at least one light-emitting diode;
an LED driver that drives and controls the at least one light-emitting diode; and
a device power source that supplies electric power to the LED driver,
wherein the LED driver comprises:
a drive current generator that supplies a desired drive current to the at least one light-emitting diode,
wherein the drive current generator comprises:
a drive transistor that is connected in series between a cathode of the at least one light-emitting diode and a ground;
a first current control portion that performs conductivity control of the drive transistor in such a way that a monitoring voltage commensurate with a current flowing through a reference resistor equals a predetermined reference voltage, and that produces an intermediate current that behaves in a same way as a drive current to be supplied to the at least one light-emitting diode;
a current mirror portion that produces a mirror current commensurate with the intermediate current at a given ratio, and that feeds the mirror current thus produced back to the reference resistor; and
a second current control portion that keeps a ratio of the drive current to the intermediate current at a given value.

11. The display device of claim 10,
wherein the at least one light-emitting diode comprises a plurality of light-emitting diodes,
wherein the LED driver comprises a plurality of the drive current generators for supplying a desired drive current to the plurality of light-emitting diodes,
wherein the plurality of the drive current generators share a point to which the reference voltage is applied.
